(19) United States
(12) Patent Application Publication
(10) Pub. No.: US 2015/0195286 A1
(43) Pub. Date: Jul. 9, 2015

(54) METHODS AND APPARATUS FOR DEVICE INFORMATION SHARING

(71) Applicants: Klaus Doppler, Albany, CA (US); Zhong-Yi Jin, Albany, CA (US); Esa Tuomaala, El Cerrito, CA (US)

(72) Inventors: Klaus Doppler, Albany, CA (US); Zhong-Yi Jin, Albany, CA (US); Esa Tuomaala, El Cerrito, CA (US)

(73) Assignee: Nokia Corporation, Espoo (FI)

(21) Appl. No.: 14/412,201

(22) PCT Filed: Aug. 15, 2012
(86) PCT No.: PCT/IB2012/054167

§ 371 Date: Mar. 22, 2015

(51) Int. Cl. H04L 29/06; H04L 29/08

(52) U.S. Cl. CPC H04L 63/101; H04L 67/104

(57) ABSTRACT

Systems and techniques for sharing data collected by sensing devices are described. At initial setup of a sensing device, authorizations for access to data collected by the device are defined. Data collected by the device is delivered to a central repository, which allows access to data by users based on authorization information associated with the users.

### TECHNICAL FIELD

The present invention relates generally to sharing of information. More particularly, the invention relates to improved systems and techniques for specifying devices accessible through a central information repository and identifying users authorized access to the specified devices.

### BACKGROUND

Numerous information gathering devices, such as weather stations, diagnostic devices for equipment, location sensors such as global positioning system receivers, home comfort sensing stations such as temperature and humidity sensors within a home, cameras for capturing still or moving images, microphones, and other information gathering devices, are or can be designed for remote communication. Other control devices, such as thermostats, alarms, and recording devices are frequently configured so that they are remotely accessible. Devices designed for remote access can, theoretically at least, be made accessible to users all over the world and many such devices do provide information accessible to any interested person.

### SUMMARY

According to one embodiment of the invention, an apparatus comprises at least one processor and memory storing computer program code. The memory storing the computer program code is configured to, with the at least one processor, cause the apparatus to at least associate an identifier of a sensing device with information identifying at least one authorizing user entitled to define authorization for a receiving user for access to data collected by the sensing device and determine at least one authorization for a receiving user for access to data collected by the sensing device.

In another embodiment of the invention, a method comprises associating an identifier of a sensing device with information identifying at least one authorizing user entitled to define authorization for a receiving user for access to data collected by the sensing device and determining at least one authorization for a receiving user for access to data collected by the sensing device.

In another embodiment of the invention, a computer readable medium stores a program of instructions. Execution of the program of instructions by a processor configures an apparatus to at least associate an identifier of a sensing device with information identifying at least one authorizing user entitled to define authorization for a receiving user for access to data collected by the sensing device and determine at least one authorization for a receiving user for access to data collected by the sensing device.

### BRIEF DESCRIPTION OF THE DRAWINGS

FIG. 1 illustrates a system according to an embodiment of the present invention;

FIG. 2 illustrates signaling conducted between elements of a system according to an embodiment of the present invention;

FIG. 3 illustrates a process according to an embodiment of the present invention; and

FIG. 4 illustrates sensing, communication, and data processing elements according to embodiments of the present invention.

### DETAILED DESCRIPTION

Embodiments of the present invention recognize that users are faced with constantly increasing numbers of devices and are putting these devices to more and more uses. Remote access to many such devices, and sharing of access to devices, can provide significant advantages, and sharing access to devices and the information gathered by devices may allow users to share information with interested persons and to allow access to information that can be used by employees and providers of services. For example, a parent of a child may equip the child with a location tracking device, and may wish to be able to grant access information gathered by the device to a group comprising themselves, nannies, grandparents, older siblings, and others, and to add persons to or remove persons from the group in a convenient way. A house may be equipped with temperature and humidity sensors and users may wish for family members and service people to have access to information collected by such sensors. Various appliances in the house, such as the water heater, furnace, washing machine, refrigerator, and other devices may be equipped with diagnostic sensors and users may wish to share access to diagnostic information with different repair services, as appropriate. A user may wish to make information collected by other types of devices, such as bird feeder cameras, pet collar cameras, garden cameras, and other similar devices accessible to more extended groups of persons, such as friends and acquaintances of the user, or even to the world at large.

However, individual users of devices, such as homeowners and parents, typically will not wish to share access to their devices without any restrictions. On the other hand, such users may find it convenient to share access to specified devices with other users, who may be individually identified or identified as members of groups having one access level or another, or access to one or more categories of devices. Many devices collect sensitive information or perform important functions, so that users will not wish to share access to such devices unless reliable mechanisms for controlling access to the devices are provided.

Users who wish to share access to their devices or to information wish to be able to decide who is to receive access, and to change their choices. Embodiments of the invention recognize that one convenient mechanism by which users classify friends, acquaintances, family members, businesses, and others is through the use of social networking. A user who has associated his or her identifier with the device may be referred to as an authorizing user for the device. A user identifier associated with a device and indicating the user having control authority over the device may be referred to as an authorizing user identifier.

One mechanism for identifying an authorizing user is association of a device with a social network identifier, and any or all of an authorizing user's devices may be associated with the authorizing user's social network identifier. One mechanism by which such association may be accomplished is through association of the social network identifier with an address of a communication device. If data collected by devices is delivered to a central repository by a communication device having a device identifier, then association of that device identifier with the authorizing user's social network identifier will serve to associate all of the authorizing user's sensing devices with that social network identifier. Sensing devices may route collected data through the communication device in order to deliver the data, and data received by the central repository may be received in association with the communication device identifier. If the communication device identifier is associated with an authorizing user identifier—for example, by the central repository, data delivered to the central repository will be identifiable with the authorizing user identifier and, for example, access authorization information associated with the authorizing user identifier.

An authorizing user may specify individuals, groups, or categories that are to have access to data gathered by the authorizing user's devices. In one or more embodiments of the invention, information collected by devices may be stored in a central repository, and access to information stored in association with a particular identifier may be made accessible depending on social network relationships, or depending on specific settings associated with the devices gathering the information.

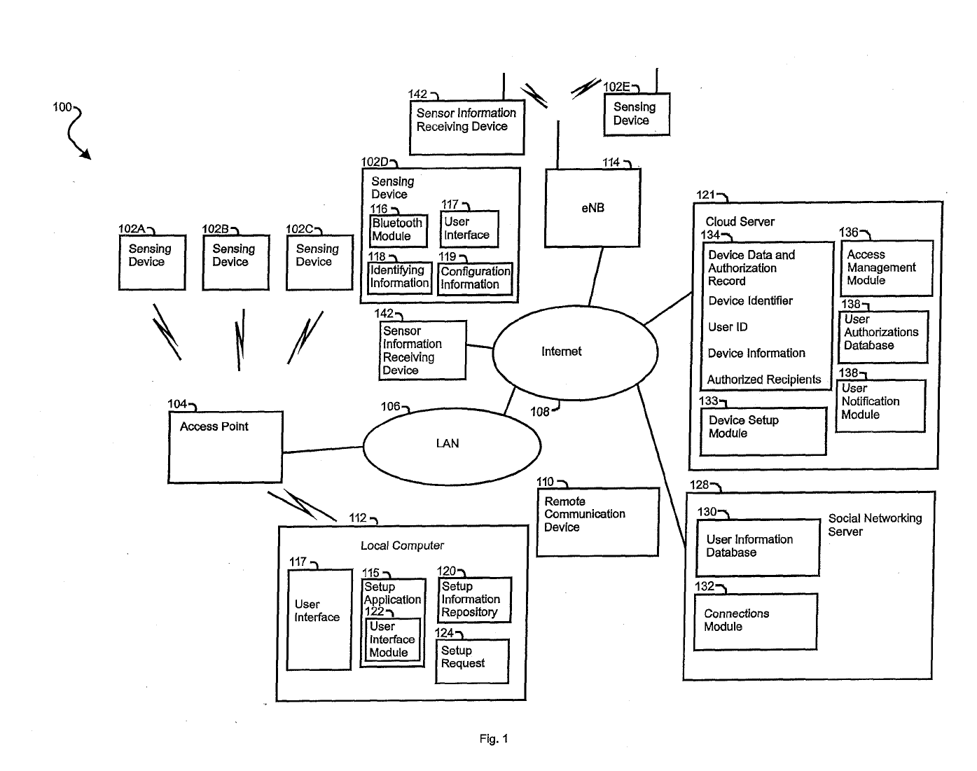

FIG. 1 illustrates a system 100 according to an embodiment of the present invention. The system comprises a plurality of sensing devices 102A-102E, all of which are capable of remote communication. Any number of different mechanisms may be used for remote communication with the sensing devices 102A-102E.

In one or more embodiments of the invention, the sensing devices 102A-102E may operate in at least two modes. One mode of operation is a setup or configuration mode, in which an identified user known to have required privileges, or having physical or proximate access to a sensing device, performs initial setup or configuration, or changes settings of or reconfigures the device. Such access can be achieved in a number of different ways.

For example, the sensing devices 102A-102D may act as a wireless network stations communicating with a remote communication access device. The remote communication access device may be, for example, a wireless network access point 104 providing access to a user local area network 106 which may in turn be connected to the public Internet 108. Such an approach allows for remote control of the sensing devices 102A-102D by a user having the needed privileges, who may communicate with the devices 102A-102D through a remote device 110 allowing access to the Internet 108 from another location. The remote device 110 may be any suitable device capable of communicating the needed information to the devices 102A-102D through a remote connection, and may be, for example, a personal computer, tablet computer, or personal communication device such as a cellular telephone or smartphone. Such devices may be, for example, configured to communicate through wireless networking or through a cellular network data connection. If the user can provide proper credentials for access to the local area network 106, such as administrator credentials, the user may be allowed to adjust settings for the devices 102A-102D. As an alternative, a local communication device, for example, a local computer 112, may communicate with the sensing devices 102A-102D through near field communication, and configuration using near field communication is discussed here in terms of configuration of the sensing device 102D. The local computer 112 may also operate as a wireless network station communicating with the access point 104, may provide a wired connection to the Internet 106, or both.

The local computer 112 is described here as serving as a configuring device for sensing devices such as the devices 102A-102D. Depending on specific configuration and operation, the device 102E may also be configured using the local computer 112, but it will be recognized that the device 102E may be expected to be configured through other mechanisms, such as its own on board interface.

The local computer 112 and the sensing device 102D may both be equipped with near field communication capability, such as through BLUETOOTH. Adjustment of settings for the sensing device 102D through such a mechanism may require that the device 102D be in proximity to the local computer 112. However, it will be recognized that the local computer 112 may be remotely controlled if appropriately configured, and it will also be recognized that numerous mechanisms for communication with the sensing device 102D may be used. For example, the sensing device 102D may be configured using a network connection through the access point 104, with the personal computer 112, or another configuring device communicating with the sensing device 102D through the network connection. In an embodiment of the invention, the sensing device 102E may operate as a user device, also known as a user equipment (UE) in a cellular communication network, gaining access to the Internet 108 through a base station 114, which may be implemented as an eNodeB (eNB). Depending on its particular configuration, the sensing device 102E may be controlled for purposes of initial setup and configuration or setup and configuration changes, through a near field communication with a device such as the local personal computer 112, through an Internet connection with the remote computer 110, or through another mechanism.

At initial setup, configuration is performed so that each of the sensing devices 102A-102E is collected data from each of the sensing devices will be associated with a particular authorizing user or set of users. For example, configuration may be performed in such a way that the data is associated with a user identifier for a data storage service or a social networking service. In the case of the devices 102A-102D, the communication device being used, such as the access point 104 or the computer 112, may be associated with the user identifier. Sensing device data delivered to, for example, a central repository, by the access point 104 or the computer 112 may therefore be recognized as being associated with the user identifier, and sensing devices associated with the access point 104 or the computer 112 will be known to be associated with the user ID because the data collected from the sensing devices will be known to be coming from the access point 104 or the computer 112. A UE such as the device 102E may typically be expected to have its own identifier and the UE's identifier. The device 102E may operate independently as a UE with its own identifier, and a network supporting the device 102E may associate the UE's identifier with a user.

The personal computer 112 may, for example, communicate with the devices 102A-102D through a local networking connection, and may provide access to the Internet 108 through a wired connection, through a wireless connection using the access point 104, or both. The remote device 110 or the local computer 112 may use a setup application 115 to perform initial setup of one or more of the sensing devices 102A-102D. The remote 110 or the local computer 112 may also be used to perform initial setup of the device 102E, or initial setup of the device 102E may be performed through other means, such as through an input interface available at the device. Suppose that setup is being performed for the sensing device 102D, which may suitably be an indoor environment sensor collecting temperature, humidity, and atmospheric pressure information. The sensing device 102D establishes a near field connection with the computer 112 using a BLUETOOTH module 116. The establishment of the near field connection may be accomplished as part of entry into a setup mode, initiated by a selection using a user interface 117. The user interface 117 may simply be a SETUP switch, or may allow for more detailed entries and selections by a user.

Suppose, then, that the sensing device 102D is activated using the user interface 117, and initial setup is selected. The sensing device 102D and the computer 112 establish a near field communication pairing and a connection, and begin to communicate using the near field connection. The computer 112 may then request identifying information from the sensing device 102D.

The sensing device 102D transfers identifying information 118 to the computer 112, which may the identifying information in a setup information repository 120. The identifying information may include a device identifier and information relating to the device type. For example, such information may identify a device as being a weather sensor, position tracker, diagnostic monitor, or other type of device. The setup information repository 120 may provide short team storage sufficient to transfer the collected information to a central repository such as a cloud server 121.

In addition to the device identifier and the device type, the computer 112 may receive configuration information 119, and may also set or update configuration information 119. Configuration information 119 may, for example, specify a subset of information to be collected, of the types of information that can be collected by the device 102D. For example, the device 102D may be capable of collecting humidity, barometric pressure, and temperature information, but may be configured to collect only temperature information. Configuration information 119 may also specify an information collection and reporting schedule, and the computer 112 may receive this information from the device 102D for transfer to the cloud server 121

As discussed in greater detail below, sensing device information may be associated with a user by or on whose behalf the sensing device is installed and configured, and one convenient way of identifying a sensing device is through association with a communication device used to transmit its data. For example, the sensing devices 102A-102D may communicate with the access point 104. An identifier, such as a media access control (MAC) address, may be present in communications delivering sensing device data to, for example, the cloud server 121. The local computer 112 may communicate setup information for the sensing devices 102A-102D through the access point 104, and the remote communication access device's identifier will naturally accompany the sensing device data as it is communicated to the cloud server 121.

During setup of the device 102D, or at any later time desired, the computer 112 may also configure access authorizations for devices such as the device. Configuration of access authorization need not involve communicating information with the device 102D relating to access authorization, because the device 102D typically will not deliver data to an authorized user. Instead, the computer 112 may set up access authorization for the cloud server 121, with the access authorization information being associated with a device identifier for the device 102D.

The setup application 115 comprises a user interface module 122, allowing a user to designate individuals, groups, or categories of persons who are to be given access to the information. In the present example, the information may be of interest to members of the user's family, so that the designated category may be “family”. For other devices, such as a diagnostic device for an appliance, one designated category may be “family adults,” and in addition either an individual repair service, more than one specifically identified repair service, or a category of repair services, such as local services providing repairs for the type of appliance in question, may be specified.

Once the application 115 has received identifying information from the device 102D and the user has made inputs using the interface module 122, the application 115 compiles a setup request 124. The setup request is conveyed to the cloud server 121, which may be a generally accessible data repository, but which may allow access to data only to persons authorized by the sender of data to receive the data. The cloud server 121 may have access to a social networking server 128, with the social networking server storing social network information for each of a number of users. The access to the social networking server 128 need only be sufficient to allow the cloud server 121 to retrieve information. Alternatively, the social networking server may be configured to deliver information to the cloud server 121, with the social networking server 128 controlling which information is delivered, and the schedule of information delivery. The social networking server 128 may, for example, deliver information, periodically, or when the information is updated. The social network information for an authorizing user may include groups of persons that may be designated in specific terms by the authorizing user. For example, a user planning a trip may specify a list of persons and define a group called “trip companions Europe vacation”. In addition, the information may include categories of persons defined with respect to their relationship to the user, such as “friends,” “acquaintances,” “family,” “parents,” “adult family,” and so on. The social networking server 128 may employ a user information database 130 storing such information, and may also employ a connections module 132 that may perform further analysis to identify, for example, persons with large numbers of friends in common with the user, or persons with large numbers of common friends who also have common interests with the user, and may include these persons in defined categories, such as “trusted persons with shared interests”. For each device for which setup information is received, the cloud server 121 retrieves specified identifiers, as well as identifiers associated with the designated groups or categories, from the social networking server 128, and identifies these users as authorized to have access to information received from the device.

The cloud server 121 may implement a device setup module 133, which may have access to information relating to addition, removal, and changes to sensing devices. The device setup module 133 may receive or recognize a setup request 124 from the computer 112, and may add or update information stored in a device data and authorizations database 134. For each device, the database 134 may store, for example, a record including, for example, the device identifier, the user ID associated with the device, the device information, and a list of authorized recipients. Once the cloud server 121 has received the required information to allow recognition of information from the device 102D, and to identify users authorized access to information from the device 102D, the cloud server 121 may send a confirmation message to the computer 112, which may in turn relay the message to the device 102D. Alternatively, the cloud server 121 may address the confirmation message directly to the device 102D

The cloud server 121 may implement an access management module 136. When a user requests access to information from a particular device, the access management module 136 may examine information stored in the device data and authorization record to determine if the user is authorized to receive the information. In one or more embodiments of the invention, the cloud server 126 may maintain a user authorizations database 138, listing for each user the devices to which the user has authorized access. The user authorizations database 138 may be compiled from the user information database 130 stored by the social networking server 128, and may also include the nature of a user's authorization—for example, authorizing user access, access only to cloud server information, direct read-only access, settings change access, deactivation access, and the like. It will be recognized that an authorization may be associated with a device, such as a personal computer, UE, or other device associated with an identifier, such as a social network identifier. It will be further recognized that an authorization associated with a device may be temporary—for example, a device may be used to log in or log out of a social network.

In one or more embodiments of the invention, the addition of a new sensing device, or changes to the information relating to a sensing device, may result in notifications to users who may be interested. Therefore, the cloud server 121 may employ a notification module 138 that examines information relating to an addition, removal, or change to a sensing device to determine which users, if any, should be notified. Criteria for notification may include the number of authorized persons, the nature of the sensing device, and whether or not the sensing device adds significant information beyond what is already available. For example, adult family members may wish to be informed of the addition of a new security camera whose access is restricted to that group, while the world in general may not wish to be notified of the addition of a bird feeder camera accessible to anyone. To take another example, notification may not be needed if an added sensing device simply adds to information provided by similar sensing devices that are already present. For example, the addition of a front yard weather station may not warrant notification if a back yard weather station is already present. Notification may be performed by any desired mechanism, such as text message, instant message, social network status update, email, or other suitable mechanism.

Once a device such as the device 102D has been configured, it then collects data and reports data to the cloud server 121 according to its configuration, such as on a periodic schedule or in response to requests, for example, by the cloud server 121 or the computer 112. Data stored by the cloud server 121 may be delivered in response to requests from authorized users or authorized devices, such as the sensor information receiving device 142. The sensor information receiving device 142 may send a request to the cloud server 121, which determines if a user of the device 142 is authorized to be given access to data collected by the device specified or encompassed by the request. If the cloud server 121 determines that access is authorized for the user of device 142, the data is delivered to the device 142. In addition or as an alternative, rather than associating authorization with user, for example, through a login identifier, authorization may be associated with a specific device identifier.

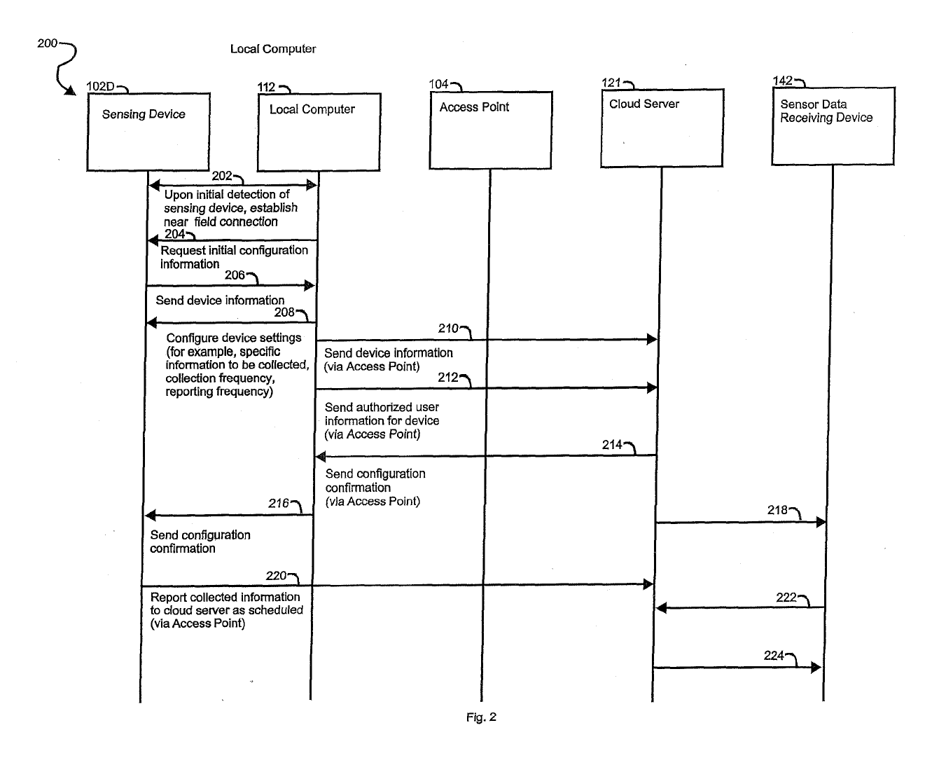

FIG. 2 illustrates a diagram 200 showing signaling taking place between various elements involved in the operation of embodiments of the invention. The elements may comprise, for example, the sensing device 102D, the computer 112, the access device 104, the cloud server 121, and the sensor information receiving device 142. The various devices are representative, and similar signaling, which may be adapted to the particular device and communication mechanism being used. Communication may take place between the device 102D and the computer 112, between the computer 112 and the cloud server 121, and between the cloud server 121 and a sensor information receiving device such as the device 142. The access point 104 may serve as a communication portal between the computer 112 and the cloud server 121, and between the sensing device 102D and the cloud server 121. In an embodiment, the computer 112 may be replaced by the remote device 110 within embodiments related to FIG. 2.

Upon initial detection of the sensing device 102D, the local computer may perform signaling 202 to establish a near field connection. The local computer 112 may then transmit a signal 204 requesting initial configuration information. The sensing device 102D may send device information 206. The local computer 112 may perform signaling 208 to configure at least a subset of device settings for the device 102D. The local computer 112 may then perform signaling 210 to send device information to the cloud server 121, for example, through the access point 104. The local computer 112 may then send a signal 212 providing authorized user information to the cloud server 121, for example, through the access point 104. In an embodiment, signals 210 and 212 may be combined.

The cloud server 121 may send a signal 214 to the local computer 112 to provide acknowledgement and/or configuration confirmation, for example, through the access point. After receiving the signal 214, the local computer 112 may perform signaling with the device 102D for finalising its setup. The cloud server 121 may send signals to sensor data receiving devices, such as the signal 218 to the device 142. These signals provide notification that a new sensing device is available. The signals such as the signal 218 may be sent only to devices with access authorization as defined by, for example, the computer 112.

The sensing device 102D collects information and sends a signal such as the signal 220 according to an information reporting schedule, which may specify, for example, periodic reporting, reporting upon request by the cloud server 121 or the local computer 121, or any other suitably schedule. When the sensor data receiving device 142 needs to receive data from the sensing device 102D, the sensor data receiving device 142 may send a request 222 to the cloud server 121, defining the device for which data is requested. The request 222 may also define the nature of the data requested. The request need not specifically define the device and data, but may express the request in more general terms, such as, for example, a request for weather data collected by the authorizing user of the device 102D, or for an area within which the device 102D lies. If the sensor data receiving device 142 is authorized to have access to the data, the cloud server 121 sends a signal 224 providing the data to the device 142.

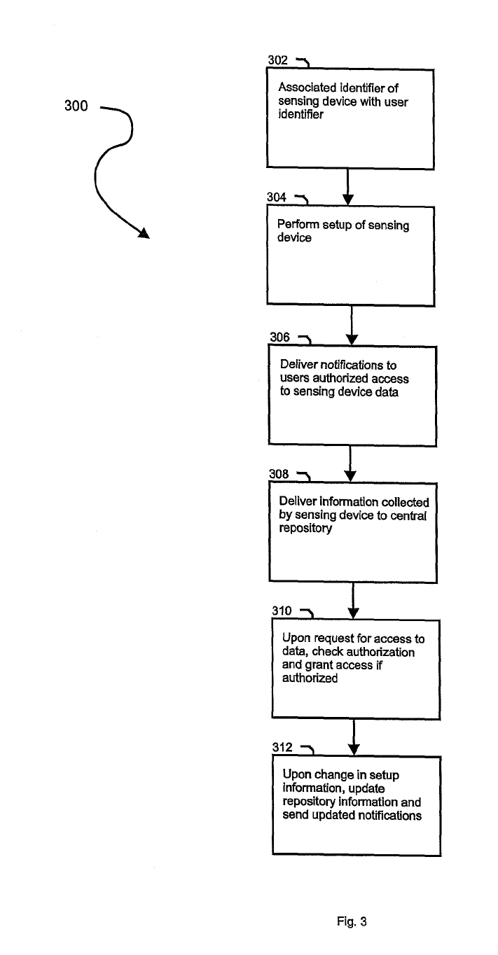

FIG. 3 illustrates a process 300 according to an embodiment of the present invention. At step 302, upon activation of a sensing device, an identifier of the device is associated with a user identifier. The association may comprise, for example, coupling the sensing device with a communication device associated with the user identifier. The user identifier may suitably be a network identifier. Alternatively, for example if the sensing device includes self-contained communication capabilities, a user identifier may be provided to the sensing device by means of a user interface. At step 304, a setup of the sensing device is performed, with the setup including designating persons authorized to receive access to data collected by the sensing device. Setup may further comprise associating the identifier of the device with information identifying the authorized recipients of access, as well as levels of access, and establishing a protocol for delivery of information collected by the device to a generally accessible data repository. The setup may further comprise the establishment of data records and authorization information relating to the device by a central repository and confirmation by the central repository that setup has been accomplished. At step 306, the central repository delivers notifications to authorized users of the presence of the sensing device, according to appropriate criteria for selecting recipients of notifications. At step 308, information collected by the sensing device is delivered to the central repository. Delivery may be according to a schedule, such as a schedule established at setup or programmed into the device, or may be performed according to other mechanisms and criteria if desired, such as upon collection of data, upon a change in the data collected, a request from an authorized user or during periods of low traffic. At step 310, upon a request from a user for access to data, the central repository determines if the user is authorized and delivers access if the user is in fact authorized. At step 312, upon a change in setup information, such as a change in the authorized users or removal of a sensing device, the central repository updates its information relating to the device and delivers updated notifications as appropriate.

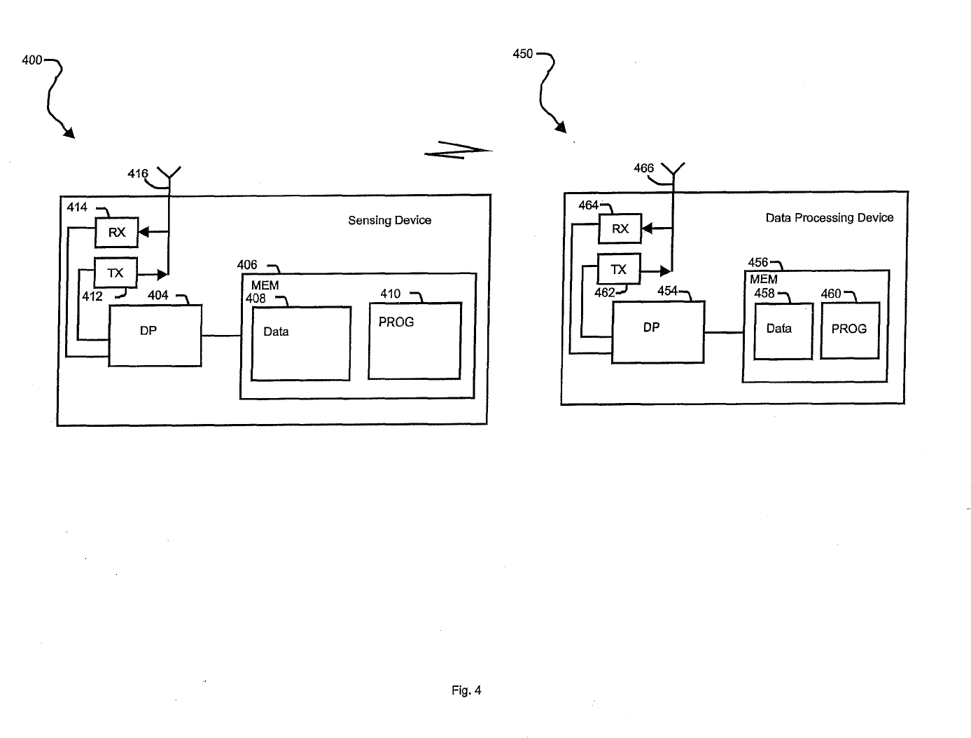

Reference is now made to FIG. 4 for illustrating a simplified block diagram of an electronic device and apparatus suitable for use in practicing the exemplary embodiments of this invention. In FIG. 4 an apparatus which may serve as a sensing device 400, which may be implemented as a mobile device/terminal such as a UE, wireless network station, or near field communication device, is adapted for communication with other apparatuses having wireless communication capability. The sensing device 400 may be a user device similar to the devices 102A-102E of FIG. 1.

The sensing device 400 includes processing means such as at least one data processor (DP) 404, storing means such as at least one computer-readable memory (MEM) 406 storing data 408, at least one computer program (PROG) 410 or other set of executable instructions, communicating means such as a transmitter TX 412 and a receiver RX 414 for bidirectional wireless communications with an eNB, wireless network access point, near field communication equipped device, or other device, via one or more antennas 416.

At least one of the PROGs 410 in the sensing device 400 is assumed to include a set of program instructions that, when executed by the associated DP 404, enable the device to operate in accordance with the exemplary embodiments of this invention, as detailed above. In these regards the exemplary embodiments of this invention may be implemented at least in part by computer software stored on the MEM 406, which is executable by the DP 404 of the device 400, or by hardware, or by a combination of tangibly stored software and hardware (and tangibly stored firmware). Electronic devices implementing these aspects of the invention need not be the entire devices as depicted at FIG. 1 or FIG. 4 or may be one or more components of same such as the above described tangibly stored software, hardware, firmware and DP, or a system on a chip SOC or an application specific integrated circuit ASIC.

In general, the various embodiments of the device 400 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEM 406 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DP 404 include but are not limited to general purpose computers, special purpose computers, microprocessors, digital signal processors (DSPs) and multi-core processors.

The sensing device 400 may communicate directly or indirectly with a data processing device 450 which may comprise a device such as a near field connection or wireless networking equipped computer, a central data repository, or one or more servers such as a cloud server or a social network server. The data processing device 450 may include processing means such as at least one data processor (DP) 454, storing means such as at least one computer-readable memory (MEM) 456 storing data 458, at least one computer program (PROG) 460 or other set of executable instructions, communicating means such as a transmitter TX 462 and a receiver RX 464 for bidirectional wireless communications with an eNB, wireless network access point, near field communication equipped device, or other device, via one or more antennas 466.

In an embodiment, bluetooth, wireless local area network, or other short range radio communication may replace near field connection/communication as described in some other embodiments.

At least one of the PROGs 460 in the device 400 is assumed to include a set of program instructions that, when executed by the associated DP 454, enable the device to operate in accordance with the exemplary embodiments of this invention, as detailed above. In these regards the exemplary embodiments of this invention may be implemented at least in part by computer software stored on the MEM 406, which is executable by the DP 454 of the device 400, or by hardware, or by a combination of tangibly stored software and hardware (and tangibly stored firmware). Electronic devices implementing these aspects of the invention need not be the entire devices as depicted at FIG. 1 or FIG. 4 or may be one or more components of same such as the above described tangibly stored software, hardware, firmware and DP, or a system on a chip SOC or an application specific integrated circuit ASIC.

In general, the various embodiments of the device 400 can include, but are not limited to personal computers, network servers, data storage systems, and other suitable mechanisms for receiving, storing, and distributing data.

Various embodiments of the computer readable MEM 456 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DP 454 include but are not limited to general purpose computers, special purpose computers, microprocessors, digital signal processors (DSPs) and multi-core processors.

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

1-22. (canceled)

23. An apparatus comprising:
at least one processor;
memory storing computer program code;
wherein the memory storing the computer program code is configured to, with the at least one processor, cause the apparatus to at least:
associate an identifier of a sensing device with information identifying at least one authorizing user entitled to define authorization for a receiving user for access to data collected by the sensing device;
determine at least one authorization for a receiving user for access to data collected by the sensing device; and
transmit a message to the sensing device directly via short range radio, the message comprising at least a subset of settings of the sensing device.

24. The apparatus of claim 23, wherein associating the identifier of the sensing device with information identifying at least one authorizing user comprises communicating with the sensing device to receive a sensing device identifier, and wherein determining at least one authorization for a receiving user comprises defining at least one authorization associated with the authorizing user and communicating with a central repository to deliver information defining the authorization for storage by the central repository.

25. The apparatus of claim 23, wherein associating the identifier of the sensing device with information identifying at least one authorizing user comprises receiving information associating data to be received from the sensing device with an identifier of an authorizing user, and wherein determining at least one authorization for a receiving user comprises receiving authorization information from a configuring device for storage in association with the identifier of the authorizing user.

26. The apparatus of claim 23, wherein associating the identifier with information defining at least one authorization of a user comprises associating a receiving user identifier with an authorizing user identifier.

27. The apparatus of claim 23, wherein the at least one authorization is defined at an initial setup of the sensing device, and wherein the at least one definition for authorization is based at least in part on social network information associated with the authorizing user identifier.

28. The apparatus of claim 23, wherein the at least one authorization comprises a set of user identifiers, each identifying a receiving user authorized access to data collected by the device.

29. The apparatus of claim 23, wherein the set of user identifiers is defined based at least in part on a category indicating a relationship between at least one receiving user and the authorizing user.

30. The apparatus of claim 23, wherein the memory storing the computer program code is further configured to, with the at least one processor, cause the apparatus to configure a notification for at least one user that access to data collected by the sensing device is available.

31. The apparatus of claim 30, wherein configuring a notification takes into account a determination of a likely level of interest of a user in data collected by the device.

32. A method comprising:
associating an identifier of a sensing device with information identifying at least one authorizing user entitled to define authorization for a receiving user for access to data collected by the sensing device; and
determining at least one authorization for a receiving user for access to data collected by the receiving device; and
transmitting a message to the sensing device directly via short range radio, the message comprising at least a subset of settings of the sensing device.

33. The method of claim 32, wherein associating the identifier of the sensing device with information identifying at least one authorizing user comprises communicating with the sensing device to receive a sensing device identifier, and wherein determining at least one authorization for a receiving user comprises defining at least one authorization associated with the authorizing user and communicating with a central repository to deliver information defining the authorization for storage by the central repository.

34. The method of claim 32, wherein associating the identifier of the sensing device with information identifying at least one authorizing user comprises receiving information associating data to be received from the sensing device with an identifier of an authorizing user, and wherein determining at least one authorization for a receiving user comprises receiving authorization information from a configuring device for storage in association with the identifier of the authorizing user.

35. The method of claim 32, wherein associating the identifier with information defining at least one authorization of a user comprises associating a receiving user identifier with an authorizing user identifier.

36. The method of claim 32, wherein the at least one authorization is defined at an initial setup of the sensing device, and wherein the at least one definition for authorization is based at least in part on social network information associated with the authorizing user identifier.

37. The method of claim 32, wherein the at least one authorization comprises a set of user identifiers, each identifying a user authorized access to data collected by the device.

38. The method of claim 37, wherein the set of user identifiers is defined based at least in part on a category indicating a relationship between at least one receiving user and the authorizing user.

39. The method of claim 32, further comprising, configuring a notification for at least one user that access to data collected by the sensing device is available.

40. The method of claim 39, wherein configuring a notification takes into account a determination of a likely level of interest of a user in data collected by the device.

41. A non-transitory computer readable medium storing a program of instructions, execution of which by a processor configures an apparatus to at least:
associate an identifier of a sensing device with information identifying at least one authorizing user entitled to define authorization for a receiving user for access to data collected by the sensing device;
determine at least one authorization for a receiving user for access to data collected by the sensing device;
transmit a message to the sensing device directly via short range radio, the message comprising at least a subset of settings of the sensing device.

42. The computer readable medium of claim 41, wherein associating the identifier of the sensing device with information identifying at least one authorizing user comprises communicating with the sensing device to receive a sensing device identifier, and wherein determining at least one authorization for a receiving user comprises defining at least one authorization associated with the authorizing user and communicating with a central repository to deliver information defining the authorization for storage by the central repository.
